(19) United States
(12) Patent Application Publication
(10) Pub. No.: US 2007/0254149 A1
(43) Pub. Date: Nov. 1, 2007

(54) Decorative Coating

(76) Inventor: Perry Philip Eckert, Mt. Eliza (AU)

Correspondence Address: DIEHL SERVILLA LLC, 77 BRANT AVE, SUITE 210, CLARK, NJ, 07066, US

(21) Appl. No.: 11/574,539

(22) PCT Filed: Apr. 8, 2005
(86) PCT No.: PCT/AU05/00518

§ 371 Date: Mar. 23, 2007

(30) Foreign Application Priority Data
Sep. 3, 2004 (AU) 2004905070

(51) Int. Cl. C09D 5/22; B05D 3/02; B32B 17/10

(52) U.S. Cl. 428/339; 106/287.22; 106/287.26; 252/301.4 R; 427/386

(57) ABSTRACT

A substrate with a decorative appearance comprising a cured coating of an epoxy and/or hydroxy containing resin component, hardener component and special effect pigment, wherein the special effect pigment is non-uniformly distributed in the cured coating.

### RELATED APPLICATIONS

This application claims priority from AU 2004905070 the entire contents of which are incorporated by reference.

### FIELD

The present invention relates to articles having new decorative appearances, and methods for creating articles with these new decorative appearances.

### BACKGROUND

Traditionally, household and commercial surfaces such as kitchen bench tops, kitchen splashbacks, floor coverings, table tops and the like are hard surfaces which are required to be cleaned easily, be durable, sanitary, and hard wearing. These characteristics mean that these surfaces are generally covered appropriately. Tiles are an example of the surface covering that provides a glossy appearance and smooth easy to clean surface. Wooden floors can be coated with a hard polyurethane coating to provide abrasion resistance. Table tops can be covered with a range of materials, e.g. stone, marble, laminex, to provide a scratch resistant, easy to clean (and sterilize) surface. Kitchen splashbacks need these properties and must also be resistant to the high temperatures associated with cooking appliances.

It is difficult to obtain surfaces having the required physical functional characteristics, and yet be aesthetically pleasing and decorative without the expense of products such as marble, toughened glass and tiles. Polyurethane coatings are usually thin and clear or coloured by single solid colour and do not currently provide any interesting decorative effect. Painting will generally only add a matte colour, with no further decorative effect or depth of field characteristics.

Various industries are faced with the issue of providing surfaces having specific functional characteristics, in combination with a decorative effect which appeals to the eye. For example, the automotive industry faces the challenge of providing new and different vehicle surfaces which are durable, water resistant, strong etc, but also appeal to the consumer. At present, decorative paint effects such as a pearlescent effect is provided on car surfaces. This requires the application of a thin solid colour base coat, and the application of a thin top layer expressing a very even and regular traditional pearlescent effect.

### SUMMARY

The present invention provides articles such as substrates having distinctive decorative appearance based on the application of a coating composition, and process for producing the article/decorative appearance.

In a first aspect, the present invention provides a substrate comprising a cured coating of an epoxy and/or hydroxy containing resin component, hardener component and special effect pigment, wherein the special effect pigment is non-uniformly dispersed in the cured coating.

The cured coating composition has a non-uniform distribution of special effect pigment resulting in a decorative pattern characterised by variation in shade and a “3-dimensional effect”. Thus, the extent of non-uniform distribution of special effect pigment should be such that a pattern can be seen by visual observation.

The use of the typically thick, transparent epoxy or hydroxy resins with special effect pigments allows for thick coating compositions to be formed, and the application technique allows for the special effect pigment to be suspended in a decorative pattern created through a non-uniform dispersion of the pigments. Unlike other thinly-applied special effect pigment-containing coating compositions, the special effect pigments are not uniformly dispersed throughout the composition before drying. Instead they are non-uniformly dispersed in the coating in accordance with a pattern applied during application of the coating, and the coating surface settles before curing to suspend the pattern in the coating with a smooth coating surface.

The coating composition preferably further comprises a suspension aid and/or a transparent colourising agent. The suspension aid may assist suspension of the special effect pigments and viscosity of the uncured coating composition. The transparent colourising agent adds a colour tint to the coating without the opacification caused by particulate pigments.

In a further aspect, the present invention provides a method of creating a decorative effect on a substrate, comprising applying a decorative coating composition comprising an epoxy and/or hydroxy containing resin component, hardener component and special effect pigment, to the substrate, creating a pattern in the applied coating in which the special effect pigment is non-uniformly dispersed in the coating composition, allowing the surface of the coating to settle, and curing the coating composition.

In an even further aspect, the present invention provides an article comprising a substrate as described above.

### BRIEF DESCRIPTION OF THE FIGURES

FIG. 1 is a photographic view of a coated substrate prepared in accordance with one embodiment of the invention.

FIG. 2 is a photographic view of a coated substrate prepared in accordance with another embodiment of the invention.

FIG. 3 is a photographic view of a coated substrate prepared in accordance with another embodiment of the invention.

### DETAILED DESCRIPTION

The decorative coating composition of the present invention provides the substrate, which is coated with the composition, with a special translucent effect, and with patterns which may be random, e.g., swirling patterns, or more ordered patterns, specifically designed for the substrate surface. The decorative coating composition provides a translucent effect, whilst being relatively viscous (on application prior to curing), which assists in suspending the special effect pigments therein, such that once the composition settles on the surface of the substrate, the pattern or image is captured within the coating. The pattern or image is 3-dimensional in appearance, meaning that the special effect pigment is non-uniformly distributed both across the surface of the coating, and within the thickness of the coating.

The epoxy and hydroxy (urethane) based coatings are waterproof, and therefore do not harbor bacteria. Consequently, the coatings provide very hygienic surfaces for food preparation areas, including commercial kitchen benches, floors, walls and splashbacks, as well as table tops. This provides significant advantages over grouted tile, timber and other porous surfaces.

The term “substrate” is used herein in a broad sense and describes any material to which a decorative coating may be applied. Examples of suitable substrates are concrete, terracotta, tiles, plasterboard, fibrocement, fibreboard, chipboard, steel, stainless steel, metal alloys, MDF, plywood, glass, laminex, fibreglass, PVC, polypropylene, polyethylene and polystyrene. The term “article” refers to any object comprising the substrate, such as a table, bench or splashback.

Components of the decorative coating composition are an epoxy and/or hydroxy containing resin component, a hardener component, and special effect pigment.

The principal resin component may be a single resin or a combination of two or more resins.

Epoxy Resin

One of the two classes of resins that may be used are the epoxy resins. The term epoxy resins is used broadly to encompass any resin containing one or more, preferably two, epoxy groups. Appropriate subclasses are the aromatic and aliphatic epoxy resins. The class of aromatic epoxy resins encompasses the Bisphenol epoxy derivatives.

Preferably the epoxy resin has a viscosity of between 1000 cps and 5000 cps, further. preferably between 2500 cps and 4500 cps and more preferably between 3000 cps and 4000 cps.

Some suitable epoxy resins are as follows:
A. diglycidyl ethers of Bisphenol A (“DGEBA”) of the formula 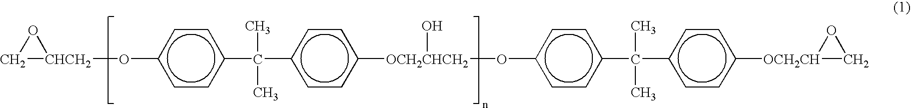
B. hydrogenated (aliphatic) diglycidyl ether of Bisphenol A 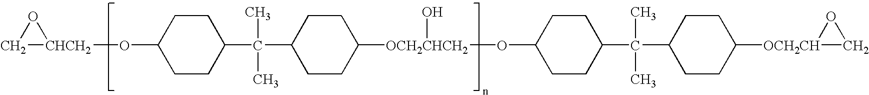
C. diglycidyl ether of Bisphenol F, of the formula 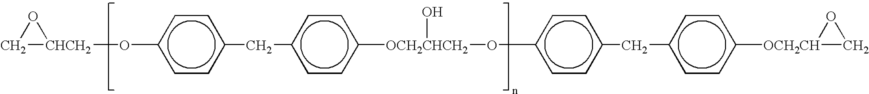
   and isomer(s) thereof;
D. polyglycol epoxies and derivatives thereof and/or
E. aliphatic mono epoxies, and derivatives thereof, suitable examples of which are butyl glycidyl ether, cresyl glycidyl ether.

The diglycidyl ether of Bisphenol F may comprise the ortho-para isomer or a combination of the para-para and ortho-para isomers.

Preferably, the Epoxy Equivalent Weight (EEW) of the epoxy resins utilised is between about 160 and 240.

In the case of each of the specific resins outlined in classes A to C above, the preferred Epoxy Equivalent Weights (EEW) are as outlined below.

In the case of A, between about 160 and about 240, preferably between about 180 and about 200. For B, the EEW may be between about 160 and about 240, preferably between about 200 and about 220. The EEW of C is preferably about 170.

A single epoxy resin may be used as the only epoxy resin component, or combinations of different resins can be used to produce coatings of varying characteristics. The choice of combinations is endless and is generally based on balancing the advantageous and disadvantageous properties of different epoxy resins against their cost. For example, exterior versions which are resistant to water and sunlight can be produced by incorporating sunlight yellowing-resistant expensive resins with some lower cost resins. Also, coating compositions with varying viscosity for ease of application can be produced.

As one example, a coating that provides thermal and water resistance and can therefore be used in external applications, comprises the following ranges of epoxy resin components: greater than about 50% of A or C, less than about 50% of D and less than about 10% of E.

In another example for exterior use the epoxy resin component of the coating composition may comprise greater than about 50% of B, less than about 50% of D and less than about 10% of E.

In another example for exterior use, the epoxy resin component of the coating composition may comprise about 70-100% of B, about 0-30% of D and about 5% of E.

In another example for exterior use, the epoxy resin component of the coating composition may comprise about 75-85% of B, about 15-25% of D and about 5% of E.

For interior use, one suitable mixture of epoxy resins comprises greater than about 50% of A or C, less than about 50% of D and less than about 10% of E.

In another example for interior use, the epoxy resin component of the cooling composition comprises about 70-90% of A or C, about 10-30% of D and less than about 5% of E.

The epoxy resin contributes the outstanding characteristics of toughness, rigidity and elevated temperature performance to the final coated substrate. The nature of the resin and the hardener component, described below, in combination, provide the coating composition with the ability to suspend the special effect pigment within the composition, thus enabling the decorative effect to be expressed.

Hydroxy Resins

The alternative class of resins that may be used are the hydroxy resins. When reacted with polyisocyanate hardeners, these form polyurethanes.

The term hydroxy resin encompasses all hydroxy-group containing resins. Preferably the hydroxy resin contains two or more hydroxy groups (commonly referred to as polyols), preferably two hydroxy groups. The polyols may be aliphatic or aromatic. The aliphatic or aromatic polyols may contain other functional groups, and may for instance be derived from polyesters or acrylics.

Two suitable classes of hydroxyl containing resins are as follows:
Hydroxylated Polyesters (both aromatic and aliphatic)
Hydroxylated Acrylics (both aromatic and aliphatic)

The “hydroxylated polyesters” are the reaction products of acids and a polyols.

The “hydroxylated acrylics” are made from acrylic or allylic monomers that contain hydroxy groups (i.e. hydroxy-functional acrylic or allylic monomers). Hydroxy ethyl methacrylate is one example of a conventional acrylic polyol monomer.

Suitable examples of allylic monomers include allyl alcohol, allyl monoethoxylate and allyl monopropoxylate. The Acryflow range of polyols are particularly suitable, and include these monomers. These monomers are chain transfer agents which increase the amount of terminal OH—functionally in the resultant polyol compared with the more conventional acrylic monomers.

The polyol is preferably a non-yellowing polyol, particularly for applications where the composition is a clear composition, or is of a colour that would be affected by the yellowing of the urethane derived from the given polyol. Of course, if the decorative coating composition is a coloured composition that is not affected by the yellowing of the urethane, the identity of the polyol is of less importance. Generally, the aliphatic polyols are non yellowing.

The polyester and acrylic polyols are preferably low viscosity materials. The viscosity of these polyols may be in the range 1000 cps and 5000 cps, preferably in the range 2500 cps and 4500 cps, more preferably in the range 3000 cps and 4000 cps. All viscosities are measured at 25° C.

The polyol resin contributes the outstanding characteristics of physical stability and good processability to the final coated substrate. The nature of the hydroxy resin and the hardener component, described below, in combination, also provide the coating composition with the ability to suspend the special effect pigment within the composition, thus enabling the decorative effect to be expressed on the final coated substrate.

Hardener

A suitable hardener is used for the specific resin chosen above. In the case of epoxy resins, the hardener is suitably an amine-based hardener. In the case of the polyol resins, the hardener is suitably based on any functional group that reacts with a polyol, such as an isocyanate. The combination of the polyol with an isocyanate hardener produces a urethane coating composition.

The hardener component of the coating composition may be a single hardener or a combination of two or more hardeners.

As noted above, where the resin is an epoxy resin, the hardener component suitably comprises an amine hardener. The term amine hardener encompasses any amine group-containing composition that reacts with an epoxide to harden the epoxy resin. The amine hardener may be a linear, branched or cyclic amine. The amine hardener may be a primary or secondary. The primary or secondary amines may be aliphatic or aromatic amines, preferably polyfunctional aliphatic or aromatic amines and their derivatives.

The amount of amine hardener used will be selected to match to the amount of the epoxy resin, and will depend on the epoxy equivalent weight of the epoxy resin used. It is within the skill of a person in the art of the invention to establish suitable ratios for given specific components based on the teaching in this document.

Preferably, the amine hardener is selected from the group comprising:
A. Linear multifunctional amines, including diethylene triamine (DETA), tetraethylene triamine (TETA) and derivatives thereof, including linear amine adducts thereof,
B. Modified aliphatic amines, such as polyether triamine.
C. Cycloaliphatic amines, and derivatives thereof.
D. Aromatic amines.

In the above preferred embodiments in which the decorative effect coating has thermal and water resistance and is therefore suitable for external applications, the amine hardener is preferably a modified aliphatic amine or polyether triamine.

In the above preferred embodiments in which the decorative effect coating is suitable for interior use, the amine hardener component comprises a cycloaliphatic amine.

The amines of group A, B and C listed above provide low odour and low irritability coating compositions, and may be preferred for this reason.

In the case where the resin is a hydroxy-containing resin, such as a polyol, the hardener is suitably an isocyanate. The term isocyanate encompasses all aromatic or aliphatic isocyanates. The isocyanate is preferably a polyisocyanate (containing two or more isocyanate groups). The isocyanate is suitably a low viscosity polyisocyanate.

The polyisocyanate is preferably a 100% solids polyisocyanate.

Suitable examples of aliphatic isocyanate hardeners include biruets of monomeric isocyanates (Bayer Desmodur® N100), trimers of monomeric isocyanates (Bayer Desmodur® N3400), Uretdiones of monomeric isocyanates (Bayer Desmodur® N3400) and allophonates (Bayer Desmodur® VP LS 2102).

A common feature of the hardeners for the epoxy and hydroxy resins outlined above is the inclusion of a nitrogen atom in the reactive group for reacting with the epoxy or hydroxy groups of the resins.

The amount of amine hardener required in the coating composition is indicated by that required by the epoxy resin component. In similar fashion, the amount of isocyanate hardener is indicated by that required by the polyol component.

Special Effect Pigment

The third component of the coating composition is a special effect pigment. Special effect pigments are a recognised class of compounds that manipulate light to create a visual effect. Generally inorganic compounds are preferred, although organic compounds can also be used to create a special visual effect. Special effect pigments are broadly exemplified by the groups transparent effect pigments (including pearlescent pigments), luminescent pigments (which exhibit fluorescence and phosphorescence), thermochromic and photochromic pigments.

Pearlescent effect pigments are transparent effect pigments which produce pearlescent or iridescent effects, and are based on platelets of low refractive index materials coated with a high refractive index material.

Luminescent pigments are materials that emit light (visible, IR or UV) upon suitable excitation, without becoming incandescent. Fluorescence is the visual effect created when a luminescent pigment is emitting light under excitation (eg, daylight fluorescent). Phosphorence is the visual effect created by the emission of light by a luminescent pigment after excitation has ceased (eg, glow in the dark).

Thermochromic pigments are those which alter colour upon exposure to heat.

Photochromic pigments are those pigments which alter colour upon exposure to a UV rich light source.

Various special effect pigments including those in the above mentioned groups can be suitably utilised in the decorative coating composition. These are commonly termed pearl-lustre pigments, metallic-effect pigments, luminescent pigments, thermochronic pigments, photochronic pigments and colour-shifting effect pigments. One or more pigments can be used in the composition depending on the desired effect.

Suitable examples of special effect pigments include Merck Xirallic® synthetic aluminium oxide platelets coated with titanium dioxide; Merck Biflair® bismuth oxychloride; Merck Ivioden® pearl lustre mica coated with metal oxides; Merck Colourstream® synthetic silica dioxide coated with refractive metal oxides; BASF Chroma® Colibri®, Pearl Lustre; BASF Chroma®, Colibri®, Pearl Lustre; Honeywell PC Lumilux® pigments; Beaver Luminescers PLC, Beaver Luminescent Pigments; Wengzhoa Kunwei Pearl Pigments Co Ltd, Pearl Pigments; Taizhu Group Corporation, Taizhu® Pearlescent Pigments; Amantech Pearlescent Pigments USA; Sumica Pearl Pigments; Changzhou Huazhu Pigments Co Ltd, Pearl Pigments, Iridescent G Series; Fitz-Chem Corporation, Concord Colour Pigments; Wezhou Kuncai Pearlescent Pigment Co Ltd, Pearl Pigments; Sirius Pearlescent Pigments; Novant Chemicals; Shantou Longhau Pearl Pigments Co Ltd, Mica Titanium Pearls; Englehard, Merlin®, Lumina®, Firemist®, Mearlite®, Sante Fe™, Black Olive™; Tritech AG, Tritium™ SPO, Super Luminous™; Glotech International Ltd, Glotech Pigments; HW Sands Corp, IR & UV Pigments and/or Cleveland Pigments & Color Co, Fluorescent Pigments.

The special effect pigment is suspended in the coating composition, the relatively high viscosity of the composition ensuring that the pigment is suspended in a manner that enables redistribution during application to a substrate to create a visual effect based on the pattern applied before curing.

In a preferred embodiment, the special effect pigment is utilised in the coating composition in an amount of less than about 5%, further preferably less than about 2%, even further preferably between about 0.1 to about 1%, and most preferably between about 0.6% to about 1% by weight relative to the total weight of the coating composition.

Preferably, the viscosity of the decorative coating composition prior to application to the substrate is between 1000 cps and 5000 cps, preferably between 2500 cps and 4500 cps, more preferably in the range 3000 cps and 4000 cps. The appropriate choice of resin, hardener and other components, usually in the absence of a thinning amount of solvent, will give a composition of this viscosity. The viscosity of the decorative coating composition is chosen to achieve a coating thickness of between 0.1 and 5 m²/1 to give a (single application) dry film thickness of approximately 0.1 mm to 5 mm. Preferably the single coating thickness is between 0.5 and 3 m²/1 to achieve a dry film thickness of approximately 0.5 mm to 3 mm.

The decorative coating composition may include further additives such as suspension aids and/or transparent colourising agents.

A suspension aid may be added to assist suspension of the special effect pigment in the composition, and to enable the decorative pattern to be created in the composition during or after application to a substrate, but before curing. Any suspension aid which acts to support the special effect pigment in the composition, or to thicken the composition, can be utilised. Suitable examples are organically modified clays such as bentonite and hectorite clays, fumed silica, attapulgite and modified ureas and polyamides.

A preferred suspension aid is an organically modified bentonite clay. The suspension aid is preferably present in an amount between about 0% to about 5%, preferably about 0% to about 2%, most preferably between about 0.5% to about 1% by weight relative to the total weight of the coating composition.

A transparent colourising agent may also be included in the coating composition. Suitable colourising agents are colour stable transparent dyes such as the range of metal complex dyes. The ratio of metal (copper or chromium) to organic complex ranges from 1:1 to 1:2 to produce a complete spectrum of primary colours, with examples such as yellow, red, blue and black. The organic component preferably contains azo or azomethine groups.

Suitable examples of transparent colourising agents include BASF Neozapon® dyes, Ciba Irgalon® dyes and Dystar UK Dystar® dyes. Transparent dyes are not usually utilised in coatings involving a resin component. However, the use of a transparent colour component assists in the formation of the decorative effect and contributes to the coated substrate having a special effect akin to liquid glass.

The colourising agent is preferably present in an amount between about 0% to about 5%, preferably about 0% to about 2%, most preferably between about 0.5% to about 1% by weight relative to the total weight of the coating composition.

The coating composition is preferably “solvent-free”. This means that the coating composition is substantially free of any solvent, aqueous, or non-aqueous. The lack of a solvent assists in the composition having a thicker consistency which contributes to the attainment of the desired decorative effect. Whilst it is understood that some optional additives may be present in small amounts of solvent and thus the composition may not be entirely free of any solvent, there is preferably no addition of solvent for the intention of solubilising the resin or hardener to complete the reaction between these components or significantly reduce the viscosity of the composition.

The choice of resin and hardener will determine the performance characteristics of the coating. Durability, hard wearing and easy to clean characteristics are desirable and obtained by use of the components described above. High performance abrasion resistance will be provided by use of the polyurethane-containing coating (derived from polyol resin and isocyanate hardener). Generally, the decorative effect coating of the invention will be suitable for floors, walls, furniture or any surface where a decorative, highly durable and wear resistant coating is required. Suitable purposes include commercial and domestic floors and kitchen splash backs, retail shops and offices, factory and showroom floors, wall art, swimming pools, shower and bathroom floors and walls, bench surfaces and table tops, wall paneling, shop fitting fixtures and a wide range of architectural decorative purposes. These items are examples of articles comprising the substrate. The substrate may be a surface of the article, or may be a separate item affixed to an article (as in the case of a table with an attached table top).

Further compounds may optionally be used in the coating composition. These include catalysts, for example curing accelerants or decelerants, such as tris-(dimethyl aminomethyl phenol, MEK or MIBK plasticizers, rheology modifiers, waxes, silicones and wetting agents.

The present invention also provides a method of manufacturing a solvent-free decorative coating composition by combining the epoxy and/or hydroxy containing resin component, the nitrogen-containing hardener component and special effect pigment. Preferably a suspension aid and/or colourising agent are added to the composition at this stage. Other optional additives may also be included at this stage.

The composition may be combined by first adding the special effect pigment and any other additive to the resin component, and then combining this with the hardener component. In the case where a suspension aid is being used, this is preferably added to the hardener component, to ensure that the final coating composition is viscous enough to carry the special effect pigment in suspension.

Once the resin component, hardener component and special effect pigment, together with any other additives are combined, it will be necessary to apply the composition to the substrate within a reasonable time, preferably within an hour, to prevent the composition from curing before application and creation of the pattern.

In an alternative embodiment, the resin component including all additives including the special effect pigment and the hardener component, including a suspension aid if required, are stored separately and combined just before use, i.e. before application to a substrate. Thus, the present invention comprises a kit for forming the decorative coating composition of the present invention comprising a first part containing the resin, a second part containing the hardener, and a special effect pigment in either of the first and second parts.

Application Techniques

The present invention also provides a method of creating a decorative effect on a substrate, comprising applying the decorative coating composition to the substrate. The composition may be applied to the substrate utilising any suitable implement, such as a trowel, spatula, blade, roller, spray and the like. The viscosity of the composition when it is applied to the substrate, prior to curing, is typically between about 1000 and 5000 cps, and may suitably be between 2500 cps and 4500 cps.

During the single-coat application of the decorative coating composition, or after application of the single coating but prior to curing, a pattern can be created in the coating by dragging through the uncured thick coating composition with any suitable implement, such as the application implements described above. This will drag the special effect pigment particles into a non-uniformly distributed pattern corresponding to the drag pattern.

After the pattern is created, the surface of the coating settles to a flat or substantially flat state, while the special effect pigments remain in the non-uniformly dispersed pattern created by the dragging action. The coating then cures (dries) over time on reaction of the resins with the hardeners. Preferably, the coating is cured at a temperature of 15° C. or more, in the case of a coating based on epoxy resins. Higher temperatures may be applied to speed up the drying process, for example the coating may be oven dried at about 50° C.

In this specification, except where the context requires otherwise due to express language or necessary implication, the word “comprise” or variations such as “comprises” or “comprising” is used in an inclusive sense, i.e. to specify the present of the stated features but not to preclude the presence or addition of further features in various embodiments of the invention.

As used in the specification the singular forms “a”, “an” and “the” include plural references unless the context clearly dictates otherwise. Thus, for example, reference to “a resin component” includes mixtures of resins, reference to “an additive” includes mixtures of two or more such additives, and the like.

### EXAMPLES

The invention will now be described with reference to the following non-limiting examples:

### Example 1

Interior Coating:

| Component | % | Supplier |
|---|---|---|
| DGEBA Epoxy resin (EEW = 190) | 50.6 | Dow Chemical - DER 331 |
| Polyglycol epoxy | 12.8 | Dow Chemical - DER 732 |
| Cycloaliphatic amine (AHEW = 113) | 34.8 | Air products |
| | | Ancamine 1618 |
| Bentonite suspension aid | 0.6 | Sud-hemie Tixogel |
| | | MP250 |
| Special effect pigment | 0.6 | Merck Irioclen Pearl |
| ising agent | 0.6 | BASF Neozapon Dyes |
| | 100% | |

### Example 2

Interior/Exterior Coating

| Component | % | Supplier |
|---|---|---|
| Polyol with Hydroxyl % of 2.73 | 74 | Lyondell Acryflow P90 |
| Isocyanate 21.7% NCO | 23 | Dow Desmoclur N3300 |
| Bentonite suspension aid | 1 | Sud-hemie Tixogel |
| | | MP250 |
| Special effect pigment | 1 | Merck Irioden Pearl |
| Colourising agent | 1 | BASF Neozapon Dyes |
| | 100% | |

### Example 3

Exterior Coating

| Component | % | Supplier |
|---|---|---|
| Aliphatic DGEBA, EEW = 210 | 72.5 | Kokdo chemicals - ST3000 |
| Polyether amine | 25.4 | Huntsman chemicals - Jeffamine |
| | | T403 |
| Bentonite suspension aid | 0.7 | Sud-hemie Tixogel |
| | | MP250 |
| Special effect pigment | 0.7 | Merck Irioden Pearl |
| Colourising agent | 0.7 | BASF Neozapon Dyes |
| | 100% | |

### Example 4

Interior Coating:

| Component | % | Supplier |
|---|---|---|
| DGEBA Epoxy resin (EEW = 190) | 47.8 | Dow Chemical - DER 331 |
| Polyglycol epoxy | 12.8 | Dow Chemical - DER 732 |
| Cycloaliphatic amine (AHEW = 113) | 34.8 | Air products |
| Fumed silica thickener | 3.4 | Aerosil 200, Degussa |
| Special effect pigment | 0.6 | Merck Irioden Pearl |
| Colourising agent | 0.6 | BASE Neozapon Dyes |
| | 100% | |

### Example 5

Interior/Exterior Coating

| Component | % | Supplier |
|---|---|---|
| Polyol with Hydroxyl % of 2.73 | 73.1 | Lyondell Acryflow P90 |
| Isocyanate 21.7% NCO | 22.7 | Dow Desmodur N3300 |
| Fumed silica thickener | 2.2 | Aerosil 200, Degussa |
| Special effect pigment | 1 | Merck Irioden Pearl |
| Colourising agent | 1 | BASF Neozapon Dyes |
| | 100% | |

### Example 6

Exterior Coating

| Component | % | Supplier |
|---|---|---|
| Aliphatic DGEBA, EEW = 210 | 71.1 | Kokdo chemicals - ST 3000 |
| Polyether amine | 25.0 | Huntsman chemicals |
| Fumed silica thickener | 2.5 | Aerosil 200, Degussa |
| Special effect pigment | 0.7 | Merck Trioden Pearl |
| Colourising agent | 0.7 | BASF Neozapon Dyes |
| | 100% | |

The coating composition of Example 1 was prepared by combining DGEBA epoxy resin (supplied by Dow Chemical) in an amount of 50.6%, Polyglycol epoxy resin (supplied by Dow Chemical) in an amount of 12.8%, a Merck Irioden Pearl special effect pigment in an amount of 0.6%, and a BASF Neozapon dye in an amount of 0.6%, and separately combining cycloaliphatic amine (Ancamine 1618) in an amount of 34.8% and Bentonite suspension aid (Sud-hemie Tixogel MP250) in an amount of 0.6%.

The two mixtures are then combined to provide a composition of viscosity 3500 cps and spread onto a fibrocement substrate using a trowel, at a thickness of 1 square metres/litre. The trowel was dragged through the composition to create a swirl effect. The substrate was then dried at 20° C. for 10 hours.

This resulted in a coated fibrocement substrate having a coating thickness of lmm and of a smooth, liquid glass appearance containing a swirl pattern.

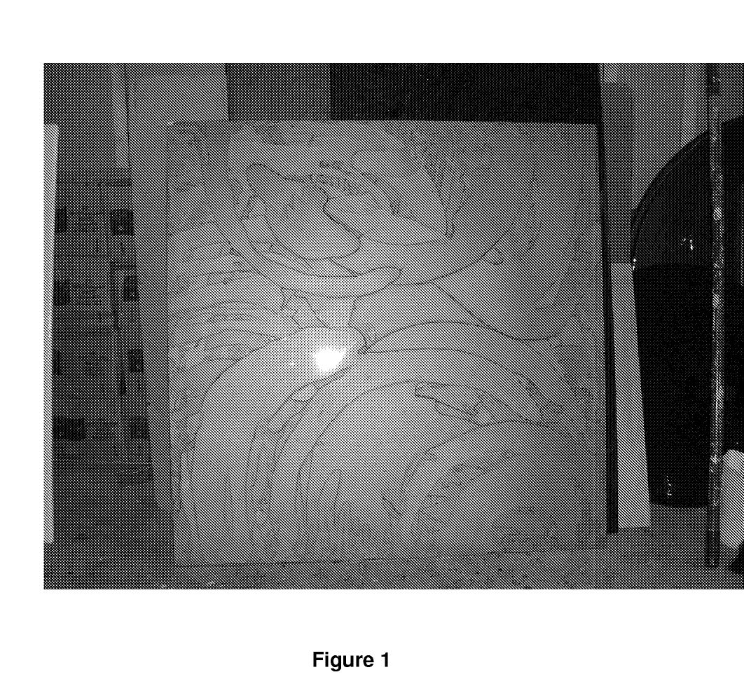

The product having a coating of Example 1 containing blue and black dye is shown in FIG. 1.

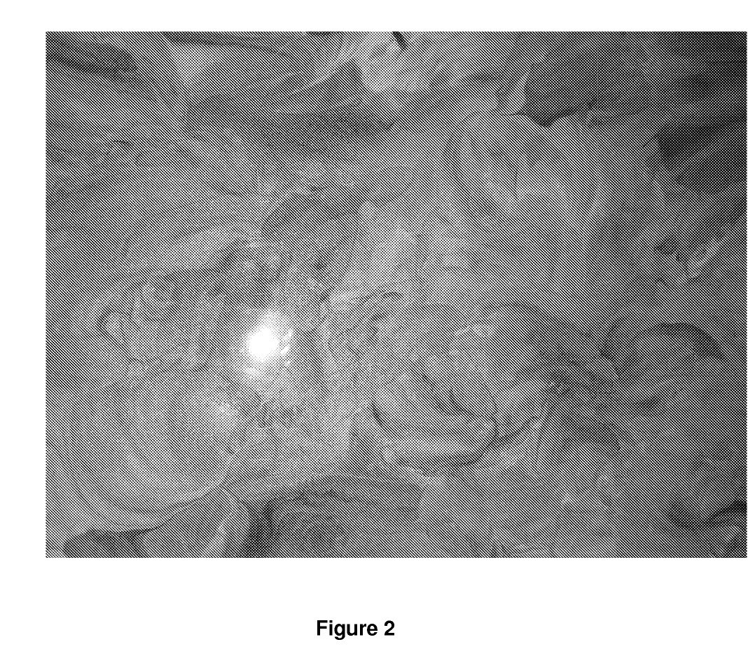

The compositions of Examples 2-6 were prepared in a similar manner to Example 1. These compositions have been applied to substrates using a range of implements, and patterns created in the uncurred coatings prior to curing. The cured coating of Example 3 with a red dye and Merck silver-white pearl lustre pigment (from the Irioden range) is shown in FIG. 2. The product has a pink shimmery appearance.

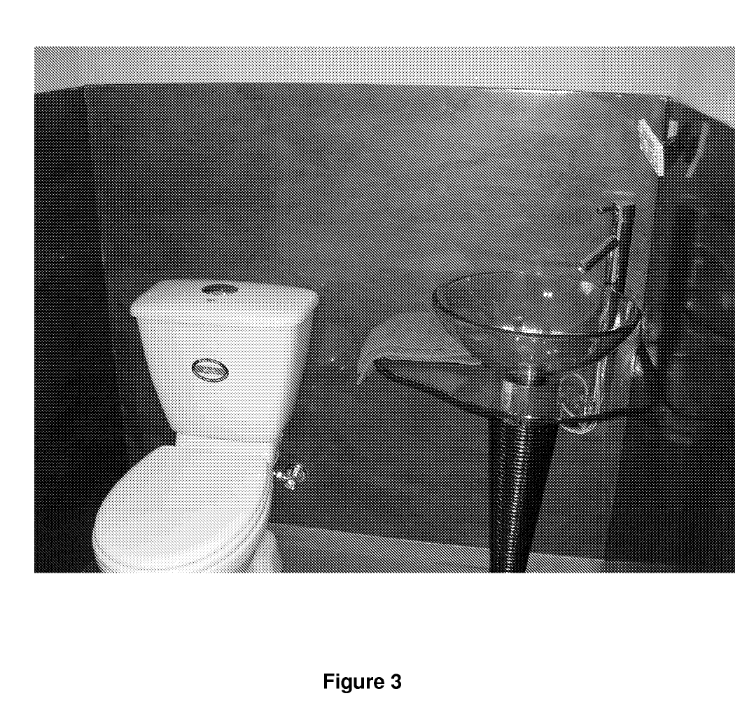

Sheeting containing a coating of Example 3 with blue dye and Merck colour stream silver pigment from the Irioden range is shown in FIG. 3, mounted to bathroom walls. This provides an attractive blue-silver-purple coloured easy to clean surface.

It will be understood to persons skilled in the art of the invention that many modifications may be made without departing from the spirit and scope of the invention.

1-45. (canceled)

46. A substrate with a smooth, flat decorative appearance comprising a single cured coating of an epoxy and/or hydroxy containing resin component, hardener component, transparent colourising agent and special effect pigment, wherein the special effect pigment is non-uniformly distributed in the cured coating and wherein the smooth flat decorative appearance is attributed to said single cured coating.

47. The substrate according to claim 46, wherein the resin component is an epoxy resin selected from one or a mixture of epoxies from the group consisting of bisphenol epoxy derivatives, polyglycol epoxies and derivatives thereof and aliphatic mono epoxies and derivatives thereof.

48. The substrate according to claim 46, wherein the epoxy resin component has an Epoxy Equivalent Weight (EEW) between 160 and 240.

49. The substrate according to claim 46, wherein the hardener is an amine hardener.

50. The substrate according to claim 46, wherein the resin component is a hydroxy-containing resin.

51. The substrate according to claim 50, wherein the hardener is an isocyanate hardener.

52. The substrate according to claim 46, wherein the resin component has a viscosity between 1000 cps and 5000 cps.

53. The substrate according to claim 46, wherein the special effect pigment is selected one or a mixture of pigments from the group consisting of transparent effect pigments; luminescent pigments; thermochromic and photochromic pigments.

54. The substrate according to claim 46, wherein the coating composition applied to the substrate and cured to produce the cured coating comprises a suspension aid.

55. The substrate according to claim 46, wherein the transparent colourising agent is present in the coating composition in an amount of up to 5% by weight, relative to the total weight of the coating composition.

56. The substrate according to claim 46, wherein the coating thickness is between 0.1 mm and 5 mm.

57. An article comprising the substrate according to claim 46, wherein said article is a wall covering, a kitchen splash back, a floor covering, an item of art, a wall panel, a swimming pool floor or a bench.

58. A method for forming a substrate with a smooth, flat decorative appearance, comprising:
applying a coating composition comprising an epoxy and/or hydroxy containing resin component, a hardener component, transparent colourising agent and special effect pigment to a substrate,
creating a pattern in the coating composition applied to the substrate in which the special effect pigment is non-uniformly dispersed in the coating composition,
allowing the surface of the coating composition to settle, and
curing the coating composition.

59. The method of claim 58, wherein the coating composition is applied in an amount of between 0.1 and 5 m²/1.
